(19) United States
(12) Patent Application Publication
(10) Pub. No.: US 2025/0326319 A1
(43) Pub. Date: Oct. 23, 2025

(54) CHARGING ADAPTER FOR ELECTRICALLY CONNECTING A MOTOR VEHICLE TO A CHARGING DEVICE

(71) Applicant: Dr. Ing. h.c. F. Porsche Aktiengesellschaft, Stuttgart (DE)

(72) Inventors: Adrian UMERLE, Stuttgart (DE); David DALLINGER, Konstanz (DE)

(21) Appl. No.: 19/182,648

(22) Filed: Apr. 18, 2025

(30) Foreign Application Priority Data
Apr. 22, 2024 (DE) 10 2024 111 135.6

(51) Int. Cl. B60L 53/66; B60L 53/16; B60L 53/18; B60L 53/30; H02J 7/00

(52) U.S. Cl. CPC B60L 53/66; B60L 53/16; B60L 53/18; B60L 53/305; H02J 7/0047; H02J 7/007192

(57) ABSTRACT

A charging adapter for electrically connecting a motor vehicle to a charging device, includes a temperature sensor and a modulator. The charging adapter is configured to be electrically connected to a first connection element and to a second connection element simultaneously. The first and second connection elements are not electrically connectable to each other. The charging adapter is configured to simultaneously transmit a transmission signal via a first cable element and a charging current via a second cable element from the charging device to the motor vehicle. The temperature sensor is configured to determine a temperature of the charging adapter and transmit the temperature to the modulator. The modulator is configured to modulate a modulation signal to a transmission signal. The modulation signal includes an indication of the temperature.

### CROSS REFERENCE TO RELATED APPLICATIONS

This application claims benefit to German Patent Application No. DE 10 2024 111 135.6, filed on Apr. 22, 2024, which is hereby incorporated by reference herein.

### FIELD

The present invention relates to a charging adapter for electrically connecting a motor vehicle to a charging device.

### BACKGROUND

For charging adapters, there are different standardizations for the connection elements in the form of plugs and sockets, for example the standards CCS1, CCS2, and NACS. A charging adapter is therefore required to connect the motor vehicle to a charging device with a connection element according to a second of the standards using a cable with a connection element according to a first of the standards.

AU 2018 332 954 A1 discloses such a charging adapter with a temperature sensor. The charging power is controlled based on the measurement data of the temperature sensor. Control signals are transmitted wirelessly or via separate signal cables.

### SUMMARY

In an embodiment, the present disclosure provides a charging adapter for electrically connecting a motor vehicle to a charging device, comprising a temperature sensor and a modulator. The charging adapter is configured to be electrically connected to a first connection element and to a second connection element simultaneously. The first and second connection elements are not electrically connectable to each other. The charging adapter is configured to simultaneously transmit a transmission signal via a first cable element and a charging current via a second cable element from the charging device to the motor vehicle. The temperature sensor is configured to determine a temperature of the charging adapter and transmit the temperature to the modulator. The modulator is configured to modulate a modulation signal to a transmission signal. The modulation signal comprises an indication of the temperature.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic circuit diagram of a system according to an embodiment of the present disclosure; and

FIG. 2 illustrates a schematic progression of a duty cycle as a function of a temperature according to an embodiment of the present disclosure.

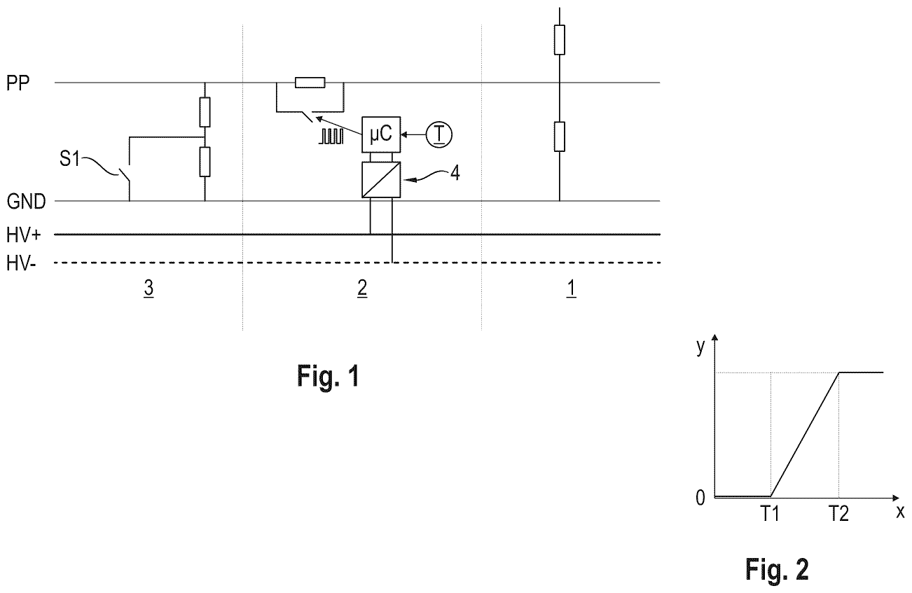

### DETAILED DESCRIPTION

In contrast known devices, embodiments of the present disclosure simplify the transmission of information about the measured temperature.

The charging adapter is configured to be electrically connected to a first connection element while simultaneously connecting to a second connection element. In the context of this description, a connection element is in particular a plug or a socket. The first connection element and the second connection element are not electrically connectable to each other. The charging adapter is configured to simultaneously transmit a transmission signal via a first cable element and a charging current via a second cable element from the charging device to the motor vehicle. The charging adapter comprises a temperature sensor and a modulation means. The temperature sensor is configured to determine a temperature of the charging adapter and transmit it to the modulation means. In the context of this description, this means in particular that information about the determined temperature is transmitted to the modulation means. For example, this information can comprise a numerical value. The modulation means is configured to modulate a modulation signal onto the transmission signal. The modulation signal comprises an indication of the temperature. In particular, the modulation signal can be temperature-dependent. In this way, information about the temperature to the motor vehicle can be transmitted without additional cable elements or other transmission paths. Therefore, a cable of the prior art, designed only for transmission of the charging current and the transmission signal, can be used without adjustments to also transmit information about the measured temperature, because transmission of this information takes place via the same cable element as transmission of the transmission signal.

For example, the transmission signal can be used to transmit information from the charging device to the motor vehicle—via the charging process, for example.

According to an embodiment of the present disclosure, the modulation signal can be a pulse width modulated signal. This is particularly advantageous for transmitting temperature information. For example, a duty cycle used in pulse width modulation can be temperature-dependent. In particular, the duty cycle can be proportional or anti-proportional to the determined temperature in at least one temperature range.

According to an embodiment of the present disclosure, the modulation means can be configured to receive energy from the charging current. Thus, the modulation means can be supplied with power in a simple manner. As the power required by the modulation means is much smaller than the power required for the charging of the energy store of the motor vehicle, the duration of the charging process is only marginally influenced.

The system according to an embodiment of the present disclosure comprises a first connection element, a third connection element, the charging adapter according to an embodiment of the present disclosure, and a cable. The cable comprises the first cable element and the second cable element. The first cable element and the second cable element can be electrically insulated from each other. The first connection element is fixed to a first end of the cable. The third connection element is fixed to a second end of the cable. The first connection element is electrically connected to the third connection element via the cable. Thus, the cable is electrically connectable to the charging device via the charging adapter, although the first connection element and the third connection element are not directly connectable to each other.

The third connection element is electrically connectable to a fourth connection element of the motor vehicle. In this way, the motor vehicle can thus be connected to the charging device to charge an energy store of the motor vehicle. The charging adapter, the first connection element, the cable, and the third connection element are configured to transmit a charging current and a transmission signal from the second connection element to the fourth connection element.

The first connection element can be configured to be electrically connected to a fifth connection element. For example, the fifth connection element can be part of another charging device, for example. In particular, the fifth connection element can differ from the second connection element.

According to an embodiment of the present disclosure, the transmission signal can be used to transmit information from the charging device to the motor vehicle. For example, information about a status of the charging device can be transmitted.

According to an embodiment of the present disclosure, the system can comprise the charging device. The charging device can be configured to output the charging current and the transmission signal.

According to an embodiment of the present disclosure, the system can comprise the motor vehicle. The motor vehicle comprises a control unit configured to receive the modulation signal and trigger a reduction of a strength of the charging current when the temperature reaches a temperature threshold value. It is in particular the reduction of the current can be triggered by the temperature reaching the temperature threshold value.

Reducing the current when the temperature reaches the threshold temperature is advantageous to reduce the risk of overheating the charging adapter. Due to the charging adapter used, the transition resistance for the charging current is increased compared to a transmission of the charging current without use of the charging adapter.

The modulation means can be configured to modulate the modulation signal onto the transmission signal only when the temperature reaches or exceeds the temperature threshold. Thus, using the control unit, it is particularly easy to detect when the temperature reaches or exceeds the temperature threshold value. Once the modulation signal is received, the temperature has reached or exceeded the temperature threshold value.

The control unit can be configured to terminate the charging process if the temperature reaches a termination threshold value. For example, the duty cycle of the pulse width modulation can be 1 or 0 once the termination threshold is determined as the temperature.

Preferably, the termination threshold value is higher than the temperature threshold value. The termination of the charging process is advantageous to reduce the risk of a fire.

The duty cycle in the temperature range between the temperature threshold value and the termination threshold value can be proportional or anti-proportional to the temperature.

In the method according to an embodiment of the present disclosure, a charging device is electrically connected to an energy store of a motor vehicle via a charging adapter, a first connection element, a cable, and a third connection element. The charging adapter is electrically connected, preferably directly, to the first connection element and a second connection element. The first connection element is fixedly electrically connected to a first end of the cable. The third connection element is fixedly electrically connected to a second end of the cable. A fixed connection is in particular understood in the context of this description to mean that the respective connection element can only be detached from the cable non-destructively with a tool. The third connection element is connectable, preferably directly, to a fourth connection element of the motor vehicle.

A charging current is transmitted from the charging device via the second connection element, the charging adapter, the first connection element, the cable, the third connection element, and the fourth connection element to the energy store. Due to the use of the charging adapter, there is a further transition resistance that can lead to additional heating compared to a charging process without using the charging adapter.

A transmission signal is transmitted during the transmission of the charging current from the charging device via the second connection element, the charging adapter, the first connection element, the cable, the third connection element, and the fourth connection element to the motor vehicle. Additionally, a temperature of the charging adapter during transmission of the charging current is determined. This can be performed with, for example, a temperature sensor.

A modulation signal is modulated on the transmission signal. The modulation signal comprises an indication of the temperature. For example, the modulation signal can be temperature-dependent. It is in particular provided that the modulation means is only modulated on the transmission signal when the temperature reaches or exceeds the temperature threshold value. Due to the modulation of the modulation signal on the transmission signal, no further cable elements are needed to transmit the indication of temperature.

The modulation signal is received by a control unit of the motor vehicle, which triggers a reduction of the strength of the charging current when the temperature reaches the temperature threshold value. For example, the event that the temperature reaches the threshold temperature value can trigger the reduction of the current of the charging current. Thus, the risk of overheating the charging adapter can be reduced.

According to an embodiment of the present disclosure, the transmission signal can be used to transmit information from the charging device to the control unit.

The method can have one or more features described in this description in connection with the charging adapter or system. For example, if it is described in this context that a component or element is configured for a function, this function can be performed in an embodiment of the method.

According to an embodiment of the present disclosure, a termination of the transmission of the charging current by the control unit can be triggered when the temperature reaches a termination threshold value. Here, the termination threshold value is higher than the temperature threshold value. By terminating the transmission of the charging current, the risk of a fire of the charging adapter is reduced.

Further features and advantages of the present disclosure are provided in the following description of a preferred exemplary embodiment, making reference to the appended drawings. Therein the same reference numerals are used for the same or similar components, features, or elements and for components, features, or elements having the same or similar functions.

An energy store 1 of a motor vehicle is electrically connected to a charging device 3 via a system. The system comprises a cable having a first connection element and a third connection element at the ends of the cable. In addition, the system comprises a charging adapter 2, via which the first connection element is electrically connected to the charging device 3. The third connection element is electrically connected to the motor vehicle. Optionally, the system 2 can also comprise the charging device 3 and/or the motor vehicle having the energy store 1.

The cable comprises a first cable element, via which a charging current with a charging voltage HV is transmitted from the charging device 3 to the energy store 1. The first cable element comprises a positive conductor HV+ and a negative conductor HV−.

In addition, the cable comprises a second cable element via which a transmission signal PP is transmitted from the charging device 3 to the energy store 1. The second cable element is electrically isolated from the first cable element. By means of a switching means S1, the transmission of the transmission signal PP can be switched on and off.

The charging adapter 2 comprises a modulation means μC, which can be configured as a microcontroller, for example. The modulation means μC is supplied with power from the charging current via a voltage transformer 4. The voltage transformer 4 converts the charging voltage HV into a lower voltage.

A temperature sensor T determines the temperature of the charging adapter and transmits the determined temperature to the modulation means μC. When the determined temperature reaches a temperature threshold value T1, the modulation means μC modulates a pulse-width modulation signal to the transmission signal PP. The modulation signal comprises an indication of the determined temperature.

If the temperature continues to rise, the duty cycle of the modulation signal is changed. As can be seen in FIG. 2, the duty cycle is proportional to the determined temperature when the temperature is greater than the temperature threshold value T1. When the temperature reaches the termination threshold value T2, the duty cycle is 1.

The transmission signal PP and the modulated modulation signal are transmitted to a control unit in the motor vehicle. When the modulation signal with the duty cycle 1 is received, the control unit terminates the transmission of the charging current. This reduces the risk of fire due to overheating the charging adapter.

When the modulation signal is received with a duty cycle of less than 1, the control unit triggers a reduction of the strength of the charging current. Thus, the risk of overheating the charging adapter is reduced.

The transmission of the indication of the temperature of the charging adapter 2 with the modulation signal is advantageous because a cable and connection elements from the prior art can be used. No further transmission path is needed for the modulation signal.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A charging adapter for electrically connecting a motor vehicle to a charging device, wherein the charging adapter is configured to be electrically connected to a first connection element and to a second connection element simultaneously, wherein the first and second connection elements are not electrically connectable to each other, wherein the charging adapter is configured to simultaneously transmit a transmission signal via a first cable element and a charging current via a second cable element from the charging device to the motor vehicle, the charging adapter comprising:
a temperature sensor; and
a modulator,
wherein the temperature sensor is configured to determine a temperature of the charging adapter and transmit the temperature to the modulator,
wherein the modulator is configured to modulate a modulation signal to a transmission signal, and
wherein the modulation signal comprises an indication of the temperature.

2. The charging adapter according to claim 1, wherein the modulation signal is a pulse width modulated signal.

3. The charging adapter according to claim 1, wherein the modulator is configured to receive energy from the charging current.

4. A system, comprising:
the charging adapter according to claim 1; and
a cable,
wherein the cable comprises the first cable element and the second cable element,
wherein the first connection element is fixed to a first end of the cable,
wherein the third connection element is fixed to a second end of the cable,
wherein the first connection element is electrically connected to the third connection element via the cable,
wherein the second connection element is a connection element of the charging device,
wherein the third connection element is electrically connectable to a fourth connection element of the motor vehicle, and
wherein the charging adapter, the first connection element, the cable, and the third connection element are configured to transmit the charging current and the transmission signal from the second connection element to the fourth connection element.

5. The system according to claim 4, wherein the transmission signal is configured to transmit information from the charging device to the motor vehicle.

6. The system according to claim 1, wherein the system comprises the charging device, and wherein the charging device is configured to output the charging current and the transmission signal.

7. The system according to claim4, wherein the system comprises the motor vehicle, and wherein the motor vehicle comprises a controller configured to receive the modulation signal and trigger a reduction of a strength of the charging current when the temperature reaches a temperature threshold value.

8. A method for charging an energy store of a motor vehicle, the method comprising:
electrically connecting a charging device to the energy store of the motor vehicle via a charging adapter, a first connection element, a cable, and a third connection element,
wherein the charging adapter is electrically connected to the first connection element and a second connection element of the charging device,
wherein the first connection element is fixedly electrically connected to a first end of the cable,
wherein the third connection element is fixedly electrically connected to a second end of the cable, and
wherein the third connection element is electrically connected to a fourth connection element of the motor vehicle;
transmitting a charging current from the charging device via the second connection element, the charging adapter, the first connection element, the cable, the third connection element, and the fourth connection element to the energy store;
transmitting a transmission signal from the charging device via the second connection element, the charging adapter, the first connection element, the cable, the third connection element, and the fourth connection element to the motor vehicle during the transmission of the charging current;
determining a temperature of the charging adapter during transmission of the charging current;
modulating a modulation signal on the transmission signal, wherein the modulation signal comprises an indication of temperature;
receiving the modulation signal by a controller of the motor vehicle; and
triggering a reduction of a current of the charging current by the controller when the temperature reaches a temperature threshold value.

9. The method according to claim 8, wherein the information is transmitted from the charging device to the controller using the transmission signal.

10. The method according to claim 8, comprising triggering a termination of the transmission of the charging current by the controller when the temperature reaches a termination threshold value.
